(19) United States
(12) Patent Application Publication
(10) Pub. No.: US 2022/0081924 A1
(43) Pub. Date: Mar. 17, 2022

(54) Support Platform for a Grain Bin Conditioning System

(71) Applicant: Illinois Grain & Seed, Inc., Cissna Park, IL (US)

(72) Inventors: Dustin K. Kurtz, Paxton, IL (US); Nathan G. Moser, Elgin, IL (US); Todd W. Kaeb, Cissna Park, IL (US); Jarod M. Luebchow, Cissna Park, IL (US)

(73) Assignee: Illinois Grain & Seed, Inc., Cissna Park, IL (US)

(21) Appl. No.: 17/304,917

(22) Filed: Jun. 28, 2021

Related U.S. Application Data
(60) Provisional application No. 62/706,875, filed on Sep. 15, 2020.

(51) Int. Cl. E04H 7/22; F04D 29/60; F16C 11/04

(52) U.S. Cl. CPC E04H 7/22; F16C 11/04; F04D 29/601

(57) ABSTRACT

A grain bin fan support has a first bracket. The first bracket has a vertical mounting plate to mount the grain bin fan support to a grain bin foundation. The bracket also has a pivot plate extending perpendicular from the vertical mounting plate. The pivot plate has a central pivot aperture, an upper aligning aperture that is arcuate with the central pivot aperture at the center point, and a lower aligning aperture that is arcuate with the central pivot aperture at the center point. A first support member is cantilevered upon the grain bin foundation by the pivot plate. The first support member has a frame forming an isosceles triangle. A first frame aperture is aligned with a line of symmetry of the frame. The grain bin fan support has a platform. The bracket, support member, and the platform have bilateral symmetry.

### CROSS REFERENCES

This application claims priority of U.S. Provisional Application No. 62/706,875 filed 15 Sep. 2020.

### FIELD OF THE INVENTION

The present disclosure relates to grain bins for drying granular material, more specifically to a support structure for supporting a conditioning system to new or existing foundations of the grain bin.

### BACKGROUND

Grain bins, silos or tanks are commonly used in the agriculture and farming industry to store commodities. These commodities typically incorporate a conditioning system to provide or maintain the appropriate temperature and humidity levels inside the bin environment. Conditioning systems generally include fans, heaters, and combinations of fans and heaters. These systems are used for aeration and conditioning of the commodity held within the grain bins. The conditioning systems are traditionally mounted on a separate concrete pad that is adjacent to the bin foundation and connected to grain bins using a transition element to direct the airflow.

### SUMMARY

A grain bin fan support for a grain bin conditioning system has a first bracket. The first bracket has a vertical mounting plate operable to mount the grain bin fan support to a grain bin foundation. The bracket also has a pivot plate extending perpendicular from the vertical mounting plate. The pivot plate has a central pivot aperture, an upper aligning aperture that is arcuate with the central pivot aperture at a center point (central pivot point), and a lower aligning aperture that is arcuate with the central pivot aperture at the center point. A first support member is cantilevered upon the grain bin foundation by the pivot plate. The first support member has a frame forming an isosceles triangle. A first frame aperture is aligned with a line of symmetry of the frame. The grain bin fan support has a platform configured to mount at a determined radially spaced apart distance from the grain bin foundation. The bracket, support member, and the platform have bilateral symmetry.

The first support member may mount to the pivot plate with a first fastener passed through the first frame aperture and the central pivot aperture. The first support member may extend radially from the grain bin foundation. The first support member may mount selectively and pivotally to the pivot plate. The frame of the first support member may have a base, a first side extending from the base, and a second side extending from the base that is symmetrical to the first side. A first set of apertures may be spaced apart along the first side for selectively securing a first platform to the first support member. A second frame aperture in the base may be positioned above the line of symmetry. A second fastener may secure the second frame aperture and the upper aligning aperture. A third frame aperture in the base may be positioned below the line of symmetry. A third fastener may secure the third frame aperture and the lower aligning aperture. The first platform may have a second set of apertures that align with a subset of the first set of apertures for mounting. The first platform may align to a top surface of the grain bin foundation by being selectively and pivotally mounted with the first support member upon the pivot plate. The first platform may have a set of cross-shaped apertures for positioning and receiving a grain bin conditioning system. The grain bin fan support may also have a transverse member having bilateral symmetry.

A method for installing a grain bin fan support for a grain bin conditioning system has the following steps. A first bracket is selected from a set of identical brackets to install at a first side of a grain bin fan support. A second bracket is selected from the set of identical brackets to install at a second side of the grain bin fan support. A first support member is selected from a set of identical support members to install at the first side of the grain bin fan support. A second support member is selected from the set of identical support members to install at the second side of the grain bin fan support. A platform is mounted between the first support member and the second support member.

The method for installing a grain bin fan support for a grain bin conditioning system may have the following steps. The first support member is pivoted upon the first bracket through a central pivot aperture of the first bracket. The platform is selectively installed at a radial distance from a grain bin foundation by aligning a first set of apertures in the platform with a second set of apertures in the first support member.

### BRIEF DESCRIPTION OF DRAWINGS

Aspects are illustrated by way of example, and not by way of limitation, in the accompanying drawings, wherein:

FIG. 1 shows a top-side perspective view of a support platform mounted to a grain bin foundation;

FIG. 2 shows an exploded top-side perspective view of a support platform;

FIG. 3 shows an assembled and unmounted top-side perspective view of a support platform;

FIG. 4 shows a side view of a pivoted support platform mounted to a pivot plate;

FIG. 5 shows a flowchart for selecting and assembling components of a support platform;

and

FIG. 6 shows a flowchart for installing a conditioning system to the support platform.

### DETAILED DESCRIPTION

The grain bin conditioning system support (“support platform”) may be properly aligned and mounted to a new or existing grain bin foundation 100. The support platform 10 may comprise a support member 12A, 12B and a bracket 20A, 20B. The support platform 10 may be formed by attaching a platform 42 to the support member fastened to the bracket. The bracket may comprise a vertical mounting plate 22A, 22B and a pivot plate 23A, 23B. The vertical mounting plate and the pivot plate may be combined as one piece or separate. The support member may be mounted to the pivot plate. The support platform may be aligned with the top surface 102 of the grain bin foundation 100 using a top alignment tab 32A, 32B. The support platform may then be properly mounted upon aligning the top alignment tab and anchoring the vertical mounting plate to the grain bin foundation. The support member is mounted such that the support member can be pivoted upon the pivot plate. The support platform provides load support for the weight of the conditioning system. The support platform may include a pair of support members and brackets that are identical and have bilateral symmetry.

The support member 12A, 12B, having bilateral symmetry, may be oriented reversibly into a left-hand or a right-hand configuration on the support platform 10. The support platform may be mounted to the grain bin foundation 100 when the vertical mounting plate 22A, 22B is anchored to the vertical sidewall 104. The support platform maintains the orientation between the conditioning system and the grain bin 200 over time. Mounting the support platform to the grain bin foundation ensures the performance of the conditioning system over time. The support platform may provide greater flexibility for adding or replacing conditioning systems for existing grain bins. The support platform may reduce the planning of an installation of a conditioning system on a new grain bin since the conditioning system can be added after the foundation has been poured and the grain bin installed.

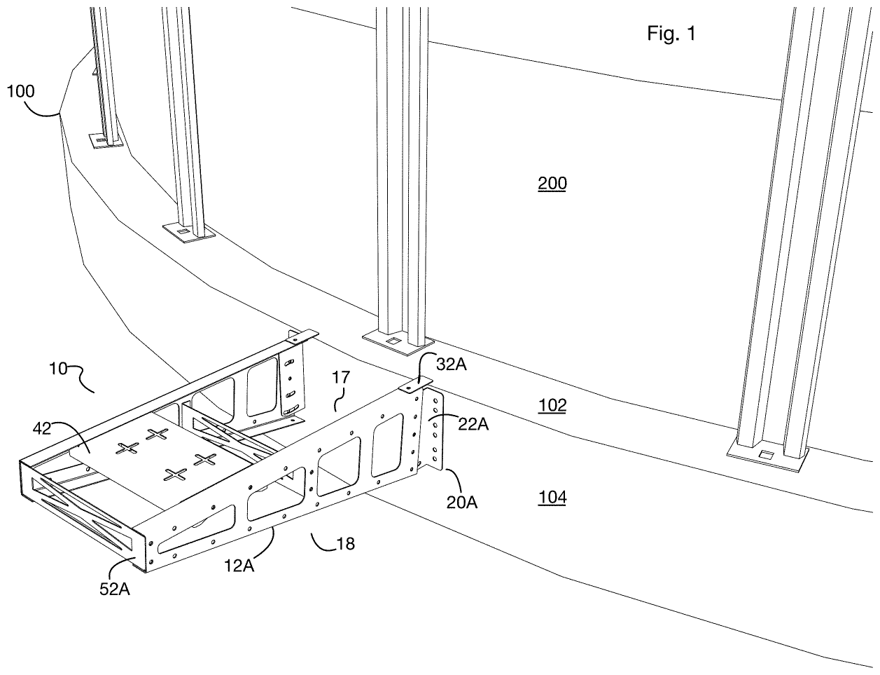

The support platform 10 for mounting a conditioning system (not shown) on an existing grain bin foundation 100 is shown in FIG. 1. The support platform is shown attached to the grain bin foundation. The support platform may comprise at least one bracket 20A, 20B and at least one platform 42. The bracket may comprise two different functional sections: a vertical mounting plate 22A, 22B and a pivot plate 23A, 23B. The grain bin 200 is shown on the top surface 102 of the grain bin foundation. The grain bin foundation has a vertical sidewall 104. The top alignment tab 32A, 32B rests on the top surface of the grain bin foundation. The vertical mounting plate rests against the vertical sidewall of the grain bin foundation.

The support platform 10 is supported by the top alignment tab 32A, 32B and the vertical mounting plate 22A, 22B. When the installer positions the support platform 10 against the grain bin foundation 100, the top alignment tab forms a flange that is aligned with the top surface 102 of the grain bin foundation. The vertical mounting plate is then aligned in the appropriate position along the vertical sidewall 104 of the grain bin foundation. Once the top alignment tab and the vertical mounting plate are properly aligned with their respective surface of the grain bin foundation, the support platform 10 can be anchored to the grain bin foundation.

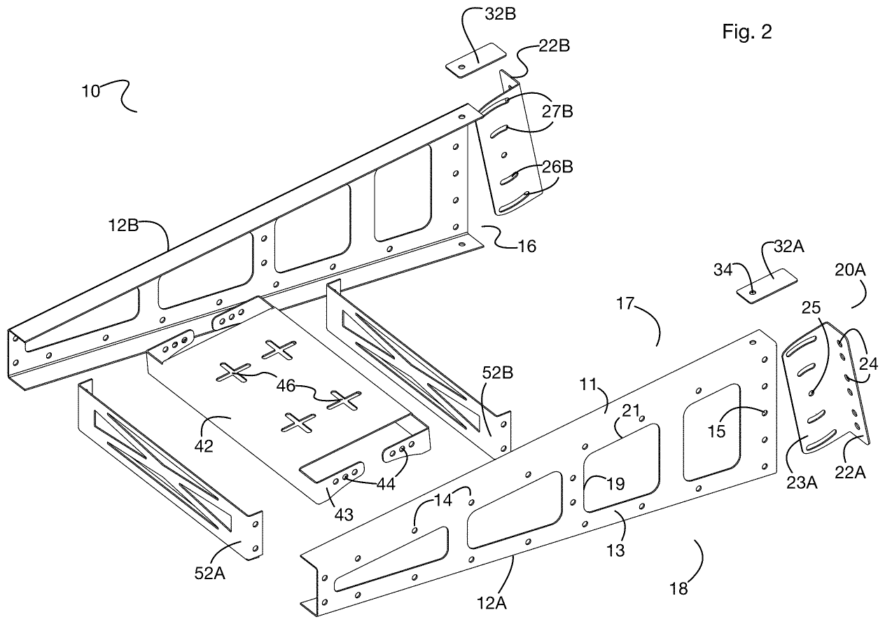

An exploded view of the individual components of a support platform 10 are shown in FIG. 2. Many types of materials and configurations may be used in constructing the support platform. Support platforms may have distinct forms such as H-shaped, I-shaped, and A-shaped. Components may be made of a durable metal, such as carbon steel, alloy steel, galvanized steel, stainless steel, iron, brass, copper, and aluminum, or other material suited for the application. The components of the support platform may have bilateral symmetry. Components of the support platform having bilateral symmetry allow for manufactured parts to be used reversibly, on either a left-hand or right-hand side of the support platform. This allows for a support platform to have a simpler design which may reduce costs associated with manufacturing, installation, and part replacement.

The vertical mounting plate 22A, 22B may be concavely curved for mounting against a vertical sidewall 104 that is annular. The vertical mounting plate may comprise a pivot plate 23A, 23B that forms a flange extending radially from the vertical mounting plate. The pivot plate has a central pivot aperture 25 disposed at the center thereof. The pivot plate also has lower aligning apertures 26A, 26B and upper aligning apertures 27A, 27B that are elongated, arc shaped, and disposed in a vertical orientation around the central pivot aperture 25. The central pivot aperture is located at a center point of the pivot plate. The lower and upper aligning apertures are arcuate with the central pivot aperture. A lower aligning aperture is arcuate with the central pivot aperture on the lower half of the pivot plate. An upper aligning aperture is arcuate with the central pivot aperture on the upper half of the pivot plate. There may be a plurality of additional lower and upper aligning apertures with varied arc lengths. Alternatively, the lower and upper aligning apertures may be disposed in the support member 12A, 12B, as discussed further below. The plurality of aligning apertures may be used to position the support platform selectively and pivotally in relation to the top surface 102 of the grain bin foundation 100 when the pour of the foundation is not square or has settled unevenly.

The support member may have a triangular frame shaped like an isosceles triangle. The frame may have a first side 17 and a second side 18 that extend from a base 16 of the frame. The first side 17 and second side 18 may be symmetrical and have equal length. A diagonal or vertical truss 19, or plurality of trusses, may support the frame between the first side 17 and the second side 18. A top support edge 11 and a bottom support edge 13 are generally perpendicular to the vertical trusses. Cutout 21 may be removed from the frame, between the trusses and the support edges, and provide a reduction in weight to the support platform 10. The trusses 19 help the frame support the weight of the conditioning system. The top support edge, first side 17 of the support member 12A12B extends radially from the grain bin foundation 100. The conditioning system may rest upon the top support edge.

The platform 42 may be selectively mounted at an adjustable distance from the grain bin foundation 100 using a plurality of frame apertures 14 disposed through the top support edge. These adjustments may accommodate transition elements of varying lengths between the conditioning system and the grain bin 200. The frame aperture 14, or plurality of frame apertures, may be spaced apart along the frame. The plurality of frame apertures 14 may be disposed through the frame along the base, the top support edge, and the bottom support edge. The frame apertures 14 provide additional areas for adjustment and attachment.

The platform 42 may be selectively mounted to be level using lower aligning apertures 26A, 26B and upper aligning apertures 27A, 27B. Lower aligning apertures 26A, 26B and upper aligning apertures 27A, 27B may be disposed through a bracket 20A, 20B and align with the frame apertures 14 disposed through a first vertical truss, or base, of the support member frame. The lower and upper aligning apertures may be positioned, as discussed above, where the elongated, arc shaped apertures are disposed in a vertical orientation around a central pivot aperture 25 in the base of the frame.

A top alignment tab 32A, 32B may be provided for positioning and mounting the support platform 10 to a grain bin foundation 100. The top alignment tab may be configured to set placement and mounting of the support member 12A, 12B against the grain bin foundation. The top alignment tab may be installed to support alignment of the frame apertures 14 of the support member with the lower and upper aligning aperture of the bracket 20A, 20B. The top alignment tab may mount to the top support edge 11 of the support member 12A, 12B and the top surface 102 of the grain bin foundation. A plurality of top alignment tabs may be used. The top alignment tab may be flat and rectangular in shape. The top alignment tab may comprise a securing aperture 34, or a plurality of securing apertures, to secure the top alignment tab to the top support edge of the support member and a top surface 102 of the grain bin foundation 100.

A transverse member 52A, 52B may be mounted to an inner surface of the support member 12A, 12B. The transverse member 52A, 52B may add structural stability to a pair of radially extending support members. Transverse member 52A is shown mounted to support members 12A, 12B at a distal end (distal to the mounting point). Transverse member 52B is show mounted between support member 12A and support member 12B at a midpoint between the distal end and a proximal mounting end of support members 12A, 12B. The transverse member may reduce torsional forces on the platform 42. Diagonal or vertical trusses 19 may support the transverse member 52A, 52B. Cutouts 21 removed from the transverse member, between the trusses 19, may provide a reduction in weight of the support platform 10.

The platform 42 may have a mounting tab 43 and a mounting aperture 44. A plurality of mounting tabs and mounting apertures may be used. The mounting tabs and mounting apertures may be spaced apart for positionally mounting the platform between the support members 12A, 12B. The mounting apertures disposed through the mounting tabs align with and provide additional areas for adjustment and attachment with the plurality of frame apertures 14 of the support members. Adjustment of the platform may be made to a variety of distances from the grain bin foundation 100 relative to a longitudinal axis—a line of symmetry (α)—of the support platform 10. The platform may have a cross-shaped aperture 46 for receiving a variety of conditioning systems. A plurality of cross-shaped apertures may be used. The cross-shaped apertures allow the conditioning system to be mounted nearer or farther from the grain bin 200. The cross-shaped apertures may allow installation of conditioning systems of a variety of different sizes, shapes, and orientations. With these features, the platform may provide a universal receiving surface for conditioning systems for receiving the mounting fasteners of the conditioning systems or receiving other units.

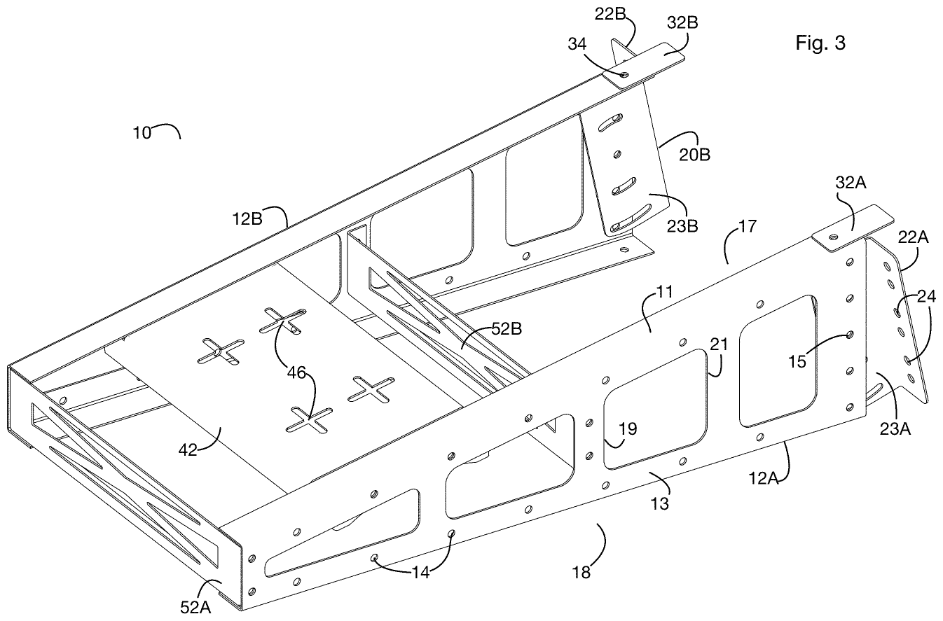

A support platform 10 assembled and unmounted is shown in FIG. 3. The components of the support platform may be held together by a plurality of fasteners installed through the plurality of apertures disposed through the components of the support platform. The fasteners may be any type of sheet metal or concrete screw or bolt, or other fastener suited for the application. The plurality of apertures may be spaced apart along the components to meet specified measurements for the intended application.

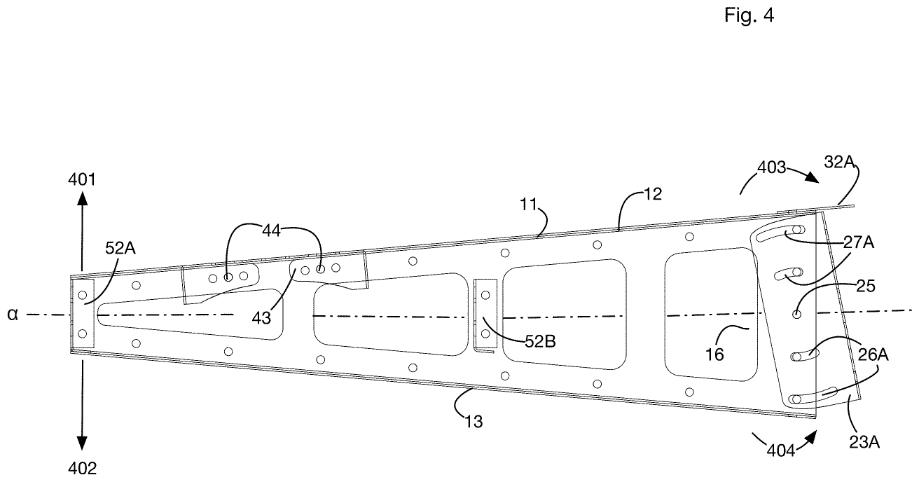

The vertical mounting plate 22A, 22B anchors the support platform 10 to the grain bin foundation 100 when fasteners are inserted through the plurality of anchoring apertures 24 into the grain bin foundation 100. The pivot plate 23A, 23B extends radially from a vertical sidewall 104 of the grain bin foundation when the vertical mounting plate is mounted to the vertical sidewall of the grain bin foundation. As illustrated in FIG. 4, the pivot plate 23A, 23B is mounted to the support member 12A, 12B by inserting a first fastener through a centering aperture 15 in the support member and the central pivot aperture 25 in the pivot plate. The support member may be selectively and pivotally positioned upward 401 or downward 402 by having a centering aperture aligned with the line of symmetry (u) of the frame of the support member. A second fastener is inserted through a lower aligning aperture 26A, 26B and a respective frame aperture 14 disposed through the support member 12A, 12B. A third fastener is inserted through an upper aligning aperture 27A, 27B and a respective frame aperture 14 disposed through the support member 12A, 12B. The support member 12A, 12B can pivot about the central pivot aperture 25 when the second and third fastener slide within the arcuately shaped lower aligning aperture 26A, 26B and the upper aligning aperture 27A, 27B. The pivot plate 23A, 23B allows the support member 12A, 12B to pivot and align the top support edge 11 of the support member with the top surface 102 of the grain bin foundation 100. This allows the platform 42 to be mounted in line with the top surface 102 of the grain bin foundation 100. Mounting the platform 42 in line with the top surface 102 keeps the bottom of a conditioner in line and flush with the grain bin foundation 100. The platform 42 extends radially from the grain bin foundation and provides a level, horizontal surface for mounting the conditioning system.

The platform 42 may be mounted between two or more support members 12A, 12B to hold the conditioning system. Fasteners may be inserted through the mounting apertures 44 in the platform to correspond with the selectively chosen frame aperture(s) 14 in the support member. The support members 12A, 12B extend perpendicular from the vertical mounting plate 22A, 22B relative to the grain bin foundation 100. The support member 12A, 12B acts as a cantilever truss for supporting the weight of a conditioning system. Additional load support and stability may be realized from the support platform 10 by adding transverse members 52A, 52B to connect the inner surface of the support members 12A, 12B one to another. The pair of support members 12A, 12B extend radially from the grain bin foundation 100 and are generally parallel with respect to each other. The top support edge 11 of the support members are at approximately the same height, or flush to one another, to level the top surface of the platform when mounted.

Best shown in FIGS. 1 and 4, the top alignment tab 32A, 32B is used to align a bracket 20A, 20B with the top surface 102 of the grain bin foundation 100 by engaging the top alignment tab with the top surface of the grain bin foundation. The vertical mounting plate 22A, 22B aligns with the vertical sidewall 104 of the grain bin foundation. Either the top alignment tab or the vertical mounting plate, or in combination, may securely anchor the support platform 10 to the grain bin foundation using a fastener, such as a concrete anchor. The support members 12A, 12B may selectively and pivotally adjust the orientation of the platform 42 relative to the grain bin foundation. The support members 12A, 12B may be pivotally mounted to the grain bin foundation through the pivot plates 23A, 23B.

The support member 12A, as shown in FIG. 4, may be leveled to a top surface 102 of an existing grain bin foundation 100. A grain bin foundation may have settled downward 402 or upward 401 or was not poured square relative to the placement location of the conditioning system. The distal end of the support member may be raised to pivot the fasteners disposed through the support member and the lower aligning apertures 26A, 26B and upper aligning apertures 27A, 27B of the pivot plate 23A, 23B in a clockwise direction 403. The distal end of the support member 12A, 12B may be lowered to pivot the fasteners disposed through the support member and the lower and upper aligning apertures of the pivot plate in a counterclockwise direction 404. These actions allow alignment of an attached platform 42 with the top surface 102 of the grain bin foundation 100 about the central pivot aperture 25 of the pivot plate. The conditioning system may be mounted on the platform 42 once the fasteners disposed through the lower and upper aligning apertures are secured. The conditioning system is connected to the grain bin 200 using a transition element (not shown).

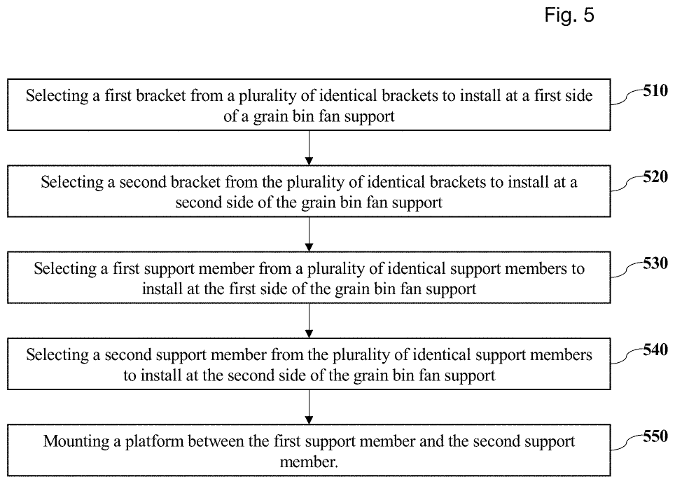

The steps of a method for selecting and assembling components of a support platform 10 are shown in FIG. 5. A first bracket 20A is selected from a plurality of identical brackets to install at a first side of a support platform, according to step 510. The first bracket may comprise a vertical mounting plate 22A and a pivot plate 23A. A second bracket 20B is selected from the plurality of identical brackets to install at a second side of the support platform, according to step 520. The second bracket may comprise a vertical mounting plate 22B and a pivot plate 23B. Optionally, the vertical mounting plate and the pivot plate may be joined together to form the bracket or be separate. A first support member 12A is selected from a plurality of identical support members to install at the first side of the support platform, according to step 530. A second support member 12B is selected from a plurality of identical support members to install at the second side of the support platform, according to step 540. A platform 42 may be mounted between the first support member 12A and the second support member 12B, according to step 550. Optionally, the first bracket 20A and the second bracket 20B may be pivoted about a central pivot aperture 25 aligned with a centering aperture 15 of the support members. Additionally, the platform may be selectively installed at a radial distance from a grain bin foundation 100. This is done by aligning mounting apertures 44 in the platform with frame apertures 14 in the first and second support member.

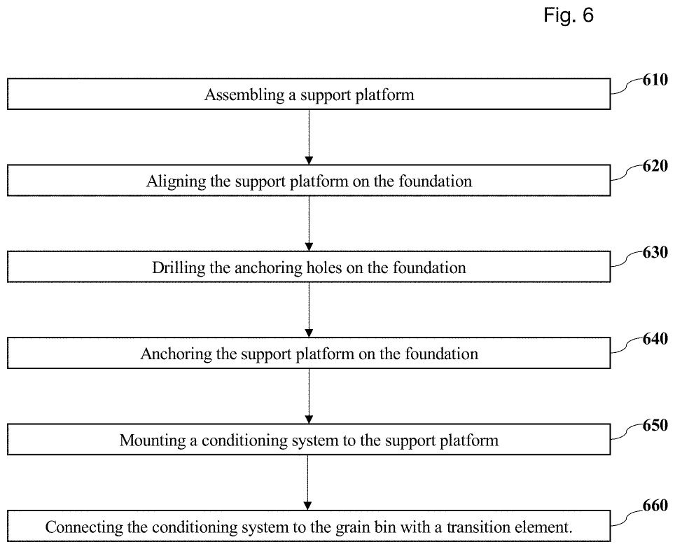

The steps of a method for mounting a support platform 10 to a grain bin foundation 100 for the installation of a conditioning system are shown in FIG. 6. The support platform is assembled, according to step 610 so that platform spacing relative to the grain bin foundation can be established. The support platform is then supported and aligned to the grain bin foundation using a top alignment tab 32A, 32B and a vertical mounting plate 22A, 22B, according to step 620. This step may occur once the top alignment tab engages the top surface 102 of the grain bin foundation and the vertical mounting plate engages the vertical sidewall 104 of the grain bin foundation. Anchors are inserted into anchoring holes for attaching the bracket 20A, 20B to the grain bin foundation. The anchoring holes may be marked through the apertures and the holes drilled out, according to step 630. Anchors may be inserted through the anchoring apertures 24 of the vertical mounting plate, the securing aperture(s) 34 of the top alignment tab, or both, into the anchoring holes disposed in the grain bin foundation. The support platform is anchored to the grain bin foundation, according to step 640, by attaching the anchors to the grain bin foundation. Optionally, the support platform may be leveled to align with the top surface of the grain bin foundation by selectively and pivotally aligning the support members 12A, 12B relative to the pivot plates 23A, 23B and tightening down the fasteners. The conditioning system is mounted to the support platform, according to step 650, by tightening down fasteners through the plurality of cross-shaped apertures 46 disposed through the platform 42. Finally, the conditioning system is connected to the grain bin 200 with a transition element, according to step 660.

It is understood that the invention is not confined to the particular construction and arrangement of parts herein described. That although the drawings and specification set forth a preferred embodiment, and although specific terms are employed, they are used in a description sense only and embody all such forms as come within the scope of the following claims.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims.

For the convenience of the reader, the above description has focused on a representative sample of all possible embodiments, a sample that teaches the principles of the invention and conveys the best mode contemplated for carrying it out. Throughout this application and its associated file history, when the term “invention” is used, it refers to the entire collection of ideas and principles described; in contrast, the formal definition of the exclusive protected property right is set forth in the claims, which exclusively control. The description has not attempted to exhaustively enumerate all possible variations. Other undescribed variations or modifications may be possible. Where multiple alternative embodiments are described, in many cases it will be possible to combine elements of different embodiments, or to combine elements of the embodiments described here with other modifications or variations that are not expressly described. A list of items does not imply that any or all of the items are mutually exclusive, nor that any or all of the items are comprehensive of any category, unless expressly specified otherwise. In many cases, one feature or group of features may be used separately from the entire apparatus or methods described. Many of those undescribed variations, modifications and variations are within the literal scope of the following claims, and others are equivalent.

We claim:

1. A grain bin fan support comprising:
a. a first bracket comprising:
i. a vertical mounting plate operable to mount to a grain bin foundation;
ii. a pivot plate extending perpendicular from the vertical mounting plate, the pivot plate comprising:
1. a central pivot aperture;
2. an aligning aperture that is arcuate with the central pivot aperture;
b. a first support member cantilevered upon the pivot plate, the first support member comprising:
i. a frame forming an isosceles triangle; and
ii. a first frame aperture aligned with a line of symmetry of the frame.

2. The grain bin fan support of claim 1, wherein the first support member is mounted to the pivot plate with a first fastener passed through the first frame aperture and the central pivot aperture.

3. The grain bin fan support of claim 1, wherein the first support member extends radially from the grain bin foundation and is selectively and pivotally mounted to the pivot plate.

4. The grain bin fan support of claim 1, wherein the frame further comprises:
a. a base;
b. a first side extending from the base; and
c. a second side extending from the base and symmetrical to the first side.

5. The grain bin fan support of claim 1, further comprising:
a. a platform configured to mount at a determined radially spaced apart distance from the grain bin foundation.

6. The grain bin fan support of claim 5, wherein the platform comprises:
a. a first plurality of apertures spaced apart along a first side for selectively securing the platform to the first support member.

7. The grain bin fan support of claim 4, further comprising:
a. a second frame aperture in the base above the line of symmetry of the frame;
b. a second fastener secures the second frame aperture and the aligning aperture; and
c. wherein the aligning aperture is an upper aligning aperture.

8. The grain bin fan support of claim 7, further comprising:
a. a third frame aperture in the base below the line of symmetry of the frame;
b. a third fastener secures the third frame aperture and the aligning aperture; and
c. wherein the aligning aperture is a lower aligning aperture.

9. A grain bin fan support, comprising:
a. a bracket;
b. a support member;
c. a platform; and
d. where each of the bracket, the support member, and the platform have bilateral symmetry.

10. The grain bin fan support of claim 9, further comprising:
a. a transverse member having bilateral symmetry.

11. The grain bin fan support of claim 9, further comprising:
a. the bracket comprising:
i. a vertical mounting plate operable to mount to a grain bin foundation;
ii. a pivot plate extending perpendicular from the vertical mounting plate, the pivot plate comprising:
1. a central pivot aperture;
2. an aligning aperture that is arcuate with the central pivot aperture; and
b. where the support member is cantilevered upon the pivot plate, the support member comprising:
i. a first frame aperture aligned with a line of symmetry of the support member.

12. The grain bin fan support of claim 9, further comprising:
a. where the support member is cantilevered upon the bracket, the support member comprising:
i. a base;
ii. a first side extending from the base; and
iii. a second side extending from the base and symmetrical to the first side;
iv. a first plurality of apertures spaced apart along the first side; and
b. where the platform has a second plurality of apertures configured to align with a subset of the first plurality of apertures to mount the platform at a determined radially spaced apart distance from a grain bin foundation.

13. A method comprising the steps of:
a. selecting a first bracket from a plurality of identical brackets to install at a first side of a grain bin fan support;
b. selecting a second bracket from the plurality of identical brackets to install at a second side of the grain bin fan support;
c. selecting a first support member from a plurality of identical support members to install at the first side of the grain bin fan support;
d. selecting a second support member from the plurality of identical support members to install at the second side of the grain bin fan support; and
e. mounting a platform between the first support member and the second support member.

14. The method of claim 13, further comprising the step of:
a. pivoting the first support member upon the first bracket through a central pivot point of the first bracket.

15. The method of claim 13, further comprising the step of:
a. installing, selectively, the platform at a radial distance from a grain bin foundation by aligning a first plurality of apertures in the platform with a second plurality of apertures in the first support member.
